(19) United States
(12) Patent Application Publication
(10) Pub. No.: US 2023/0345021 A1
(43) Pub. Date: Oct. 26, 2023

(54) EFFICIENT STORAGE OF DATA FOR A MULTI-STAGE TWO-DIMENSIONAL TRANSFORM

(71) Applicant: Meta Platforms, Inc., Menlo Park, CA (US)

(72) Inventors: Zhao Wang, Newark, CA (US); Yunqing Chen, Los Altos, CA (US); Baheerathan Anandharengan, Milpitas, CA (US)

(21) Appl. No.: 17/525,135

(22) Filed: Nov. 12, 2021

(51) Int. Cl. H04N 19/423; H04N 19/124; H04N 19/147; H04N 19/60

(52) U.S. Cl. CPC H04N 19/423; H04N 19/124; H04N 19/147; H04N 19/60; H04N 19/139

(57) ABSTRACT

A system for storing and retrieving data for a multi-stage two-dimensional transform is disclosed. The system comprises a memory comprising storage elements arranged in a physical grid with physical rows and physical columns, wherein values stored in a same physical column are not simultaneously accessible. A processing unit is configured to receive data elements of a certain logical row of a dataset arranged in logical rows and logical columns for storage in a certain physical row of the physical grid of the memory. The processing unit is configured to circularly shift the data elements based on a shift offset associated with the certain physical row. The processing unit is configured to provide for storage in the certain physical row of the physical grid of the memory the circularly shifted data elements to enable a logical column of the dataset to be read together from different physical columns.

### BACKGROUND

A video coding format is a content representation format for storage or transmission of digital video content (such as in a data file or bitstream). It typically uses a standardized video compression algorithm. Examples of video coding formats include H.262 (MPEG-2 Part 2), MPEG-4 Part 2, H.264 (MPEG-4 Part 10), HEVC (H.265), Theora, RealVideo RV40, VP9, and AV1. A video codec is a device or software that provides encoding and decoding for digital video. Most codecs are typically implementations of video coding formats.

Recently, there has been an explosive growth of video usage on the Internet. Some websites (e.g., social media websites or video sharing websites) may have billions of users and each user may upload or download one or more videos each day. When a user uploads a video from a user device onto a website, the website may store the video in one or more different video coding formats, each being compatible with or more efficient for a certain set of applications, hardware, or platforms. Therefore, higher video compression rates are desirable. For example, VP9 offers up to 50% more compression compared to its predecessor. However, with higher compression rates come higher computational complexity; therefore, improved hardware architecture and techniques in video coding would be desirable.

### BRIEF DESCRIPTION OF THE DRAWINGS

Various embodiments of the disclosure are disclosed in the following detailed description and the accompanying drawings.

FIG. 1 illustrates a block diagram of an embodiment of a video encoder 100.

FIG. 2 illustrates an exemplary block diagram of RDO module 130.

FIG. 3 illustrates an example 300 of a 2-dimensional transform of an 8×8 residue pixel block 302 performed by two stages of transform modules.

FIG. 4 illustrates an exemplary process 400 for storing and retrieving data.

FIG. 5 illustrates an example 500 of a 2-dimensional transform of an 8×8 residue pixel block 502 performed by two stages of transform modules.

### DETAILED DESCRIPTION

The disclosure can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the disclosure may take, may be referred to as techniques. In general, the order of the steps of disclosed processes may be altered within the scope of the disclosure. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the disclosure is provided below along with accompanying figures that illustrate the principles of the disclosure. The disclosure is described in connection with such embodiments, but the disclosure is not limited to any embodiment. The scope of the disclosure is limited only by the claims and the disclosure encompasses numerous alternatives, modifications and equivalents. Numerous specific details are set forth in the following description in order to provide a thorough understanding of the disclosure. These details are provided for the purpose of example and the disclosure may be practiced according to the claims without some or all of these specific details. For the purpose of clarity, technical material that is known in the technical fields related to the disclosure has not been described in detail so that the disclosure is not unnecessarily obscured.

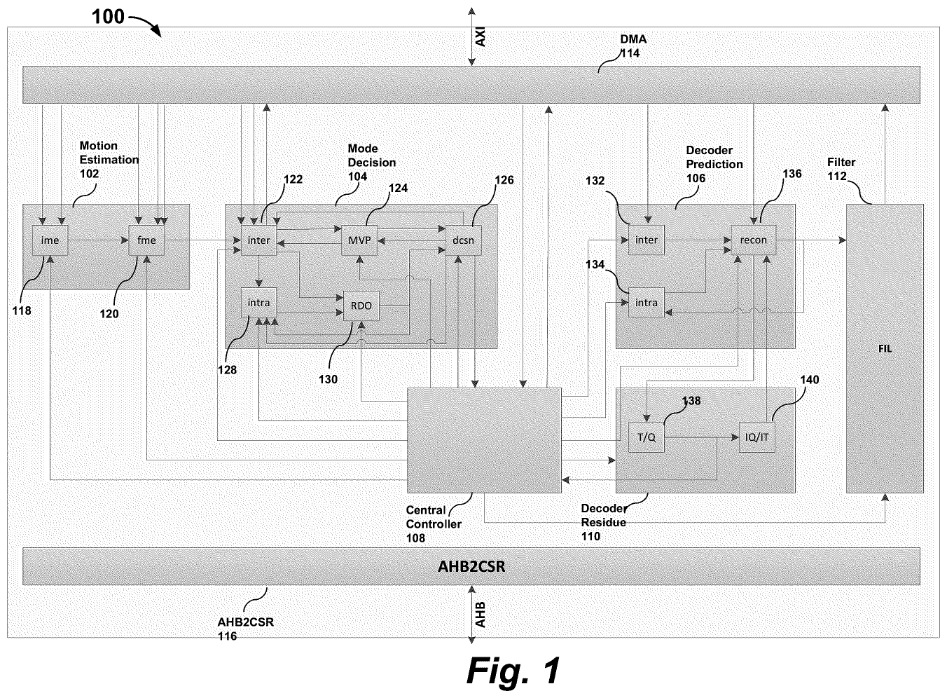

FIG. 1 illustrates a block diagram of an embodiment of a video encoder 100. For example, video encoder 100 supports the video coding format VP9. However, video encoder 100 may also support other video coding formats as well, such as H.262 (MPEG-2 Part 2), MPEG-4 Part 2, H.264 (MPEG-4 Part 10), HEVC (H.265), Theora, and RealVideo RV40.

Video encoder 100 includes many modules. Some of the main modules of video encoder 100 are shown in FIG. 1. As shown in FIG. 1, video encoder 100 includes a direct memory access (DMA) controller 114 for transferring video data. Video encoder 100 also includes an AMBA (Advanced Microcontroller Bus Architecture) to CSR (control and status register) module 116. Other main modules include a motion estimation module 102, a mode decision module 104, a decoder prediction module 106, a central controller 108, a decoder residue module 110, and a filter 112.

Video encoder 100 includes a central controller module 108 that controls the different modules of video encoder 100, including motion estimation module 102, mode decision module 104, decoder prediction module 106, decoder residue module 110, filter 112, and DMA controller 114.

Video encoder 100 includes a motion estimation module 102. Motion estimation module 102 includes an integer motion estimation (IME) module 118 and a fractional motion estimation (FME) module 120. Motion estimation module 102 determines motion vectors that describe the transformation from one image to another, for example, from one frame to an adjacent frame. A motion vector is a two-dimensional vector used for inter-frame prediction; it refers the current frame to the reference frame, and its coordinate values provide the coordinate offsets from a location in the current frame to a location in the reference frame. Motion estimation module 102 estimates the best motion vector, which may be used for inter prediction in mode decision module 104. An inter coded frame is divided into blocks, e.g., prediction units or partitions within a macroblock. Instead of directly encoding the raw pixel values for each block, the encoder will try to find a block similar to the one it is encoding on a previously encoded frame, referred to as a reference frame. This process is done by a block matching algorithm. If the encoder succeeds on its search, the block could be encoded by a vector, known as a motion vector, which points to the position of the matching block at the reference frame. The process of motion vector determination is called motion estimation.

Video encoder 100 includes a mode decision module 104. The main components of mode decision module 104 include an inter prediction module 122, an intra prediction module 128, a motion vector prediction module 124, a rate-distortion optimization (RDO) module 130, and a decision module 126. Mode decision module 104 detects one prediction mode among a number of candidate inter prediction modes and intra prediction modes that gives the best results for encoding a block of video.

Intra prediction is the process of deriving the prediction value for the current sample using previously decoded sample values in the same decoded frame. Intra prediction exploits spatial redundancy, i.e., correlation among pixels within one frame, by calculating prediction values through extrapolation from already coded pixels for effective delta coding. Inter prediction is the process of deriving the prediction value for the current frame using previously encoded reference frames. Inter prediction exploits temporal redundancy.

Rate-distortion optimization (RDO) is the optimization of the amount of distortion (loss of video quality) against the amount of data required to encode the video, i.e., the rate. RDO module 130 provides a video quality metric that measures both the deviation from the source material and the bit cost for each possible decision outcome. Both inter prediction and intra prediction have different candidate prediction modes, and inter prediction and intra prediction that are performed under different prediction modes may result in final pixels requiring different rates and having different amounts of distortion and other costs.

For example, different prediction modes may use different block sizes for prediction. In some parts of the image there may be a large region that can all be predicted at the same time (e.g., a still background image), while in other parts there may be some fine details that are changing (e.g., in a talking head) and a smaller block size would be appropriate. Therefore, some video coding formats provide the ability to vary the block size to handle a range of prediction sizes. The decoder decodes each image in units of superblocks (e.g., 128×128 or 64×64 pixel superblocks). Each superblock has a partition that specifies how it is to be encoded. Superblocks may be divided into smaller blocks according to different partitioning patterns. This allows superblocks to be divided into partitions as small as 4×4 pixels.

Besides using different block sizes for prediction, different prediction modes may use different settings in inter prediction and intra prediction. For example, there are different inter prediction modes corresponding to using different reference frames, which have different motion vectors. For intra prediction, the intra prediction modes depend on the neighboring pixels, and in VP9, the modes include DC, Vertical, Horizontal, TM (True Motion), Horizontal Up, Left Diagonal, Vertical Right, Vertical Left, Right Diagonal, and Horizontal Down.

RDO module 130 receives the output of inter prediction module 122 corresponding to each of the inter prediction modes and determines their corresponding amounts of distortion and rates, which are sent to decision module 126. Similarly, RDO module 130 receives the output of intra prediction module 128 corresponding to each of the intra prediction modes and determines their corresponding amounts of distortion and rates, which are also sent to decision module 126.

In some embodiments, for each prediction mode, inter prediction module 122 or intra prediction module 128 predicts the pixels, and the residual data (i.e., the differences between the original pixels and the predicted pixels) may be sent to RDO module 130, such that RDO module 130 may determine the corresponding amount of distortion and rate. For example, RDO module 130 may estimate the amounts of distortion and rates corresponding to each prediction mode by estimating the final results after additional processing steps (e.g., applying transforms and quantization) are performed on the outputs of inter prediction module 122 and intra prediction module 128.

Decision module 126 evaluates the cost corresponding to each inter prediction mode and intra prediction mode. The cost is based at least in part on the amount of distortion and the rate associated with the particular prediction mode. In some embodiments, the cost (also referred to as rate distortion cost, or RD Cost) may be a linear combination of the amount of distortion and the rate associated with the particular prediction mode; for example, RD Cost=distortion+λ*rate, where λ is a Lagrangian multiplier. The rate includes different components, including the coefficient rate, mode rate, partition rate, and token cost/probability. Other additional costs may include the cost of sending a motion vector in the bit stream. Decision module 126 selects the best inter prediction mode that has the lowest overall cost among all the inter prediction modes. In addition, decision module 126 selects the best intra prediction mode that has the lowest overall cost among all the intra prediction modes. Decision module 126 then selects the best prediction mode (intra or inter) that has the lowest overall cost among all the prediction modes. The selected prediction mode is the best mode detected by mode decision module 104.

After the best prediction mode is selected by mode decision module 104, the selected best prediction mode is sent to central controller 108. Central controller 108 controls decoder prediction module 106, decoder residue module 110, and filter 112 to perform a number of steps using the mode selected by mode decision module 104. This generates the inputs to an entropy coder that generates the final bitstream. Decoder prediction module 106 includes an inter prediction module 132, an intra prediction module 134, and a reconstruction module 136. If the selected mode is an inter prediction mode, then the inter prediction module 132 is used to do the inter prediction, whereas if the selected mode is an intra prediction mode, then the intra prediction module 134 is used to do the intra prediction. Decoder residue module 110 includes a transform and quantization module (T/Q) 138 and an inverse quantization and inverse transform module (IQ/IT) 140.

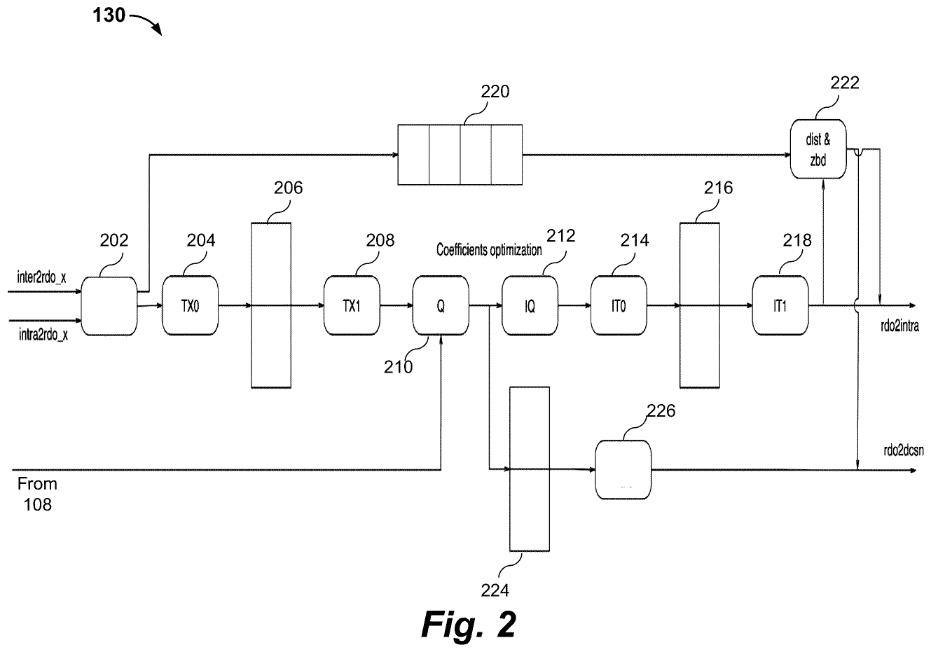

FIG. 2 illustrates an exemplary block diagram of RDO module 130. RDO module 130 includes an arbiter and buffer module 202 for receiving inputs from inter prediction module 122 and intra prediction module 128, respectively. The received inputs include the residue data (i.e., the differences between the source/original pixels and the predicted pixels) corresponding to different prediction modes. The residue data is referred to as the original residue, given by original residue=source pixels−predicted pixels. These residues are then transformed using a 2-dimensional transform performed by two stages of transform modules, TX0 module 204 and TX1 module 208, with a transpose operation module 206 in between. After the transform, the transformed values form a transform block, which is a square transform coefficient matrix with a DC coefficient and a plurality of AC coefficients. The transform coefficients are then compressed further by quantizing the coefficients via a quantization module 210.

Distortion may be based on the original residue=source pixels−predicted pixels and the reconstruction residue. For example, one metric is the sum of the squared estimate of errors (SSE), the sum of the squares of the original residue. In order to estimate the amounts of distortion experienced by the decoder, a number of processing steps are performed on the quantized coefficients. Inverse quantization (i.e., dequantization) is performed by a dequantization module 212 and an inverse transform is performed by two stages of inverse transform modules, IT0 module 214 and IT1 module 218, with a transpose operation module 216 in between. The results after the inverse transform are then compared with the original block of residual pixels at the output of a buffer 220 by a distortion estimation module 222, such that the amounts of distortion corresponding to different prediction modes are determined and sent to decision module 126.

The rates associated with sending the data corresponding to a block in a bitstream are also estimated by RDO module 130. One component of the rate is the coefficient rate, which is the rate associated with sending the quantized coefficients in the bitstream. The quantized coefficients at the output of quantization module 210 are sent to a ping-pong buffer 224 and a token rate module 226, where the rate associated with a particular block may be estimated. The rates are estimated by token rate module 226 without performing the actual encoding, because the actual encoding of the bitstream is computationally intensive and requires additional information, e.g., neighbor dependency or other neighbor information, which is not available. Coefficient rate estimation by token rate module 226 is performed for every transform unit (TU) that goes through the RDO process in mode decision module 104. The rate estimation is based on the quantized coefficients.

One of the challenges is the design and implementation of a high throughput and low cost 2-dimensional transform. As described above, the residues are transformed using a 2-dimensional transform performed by two stages of transform modules, TX0 module 204 and TX1 module 208, with a transpose operation module 206 in between.

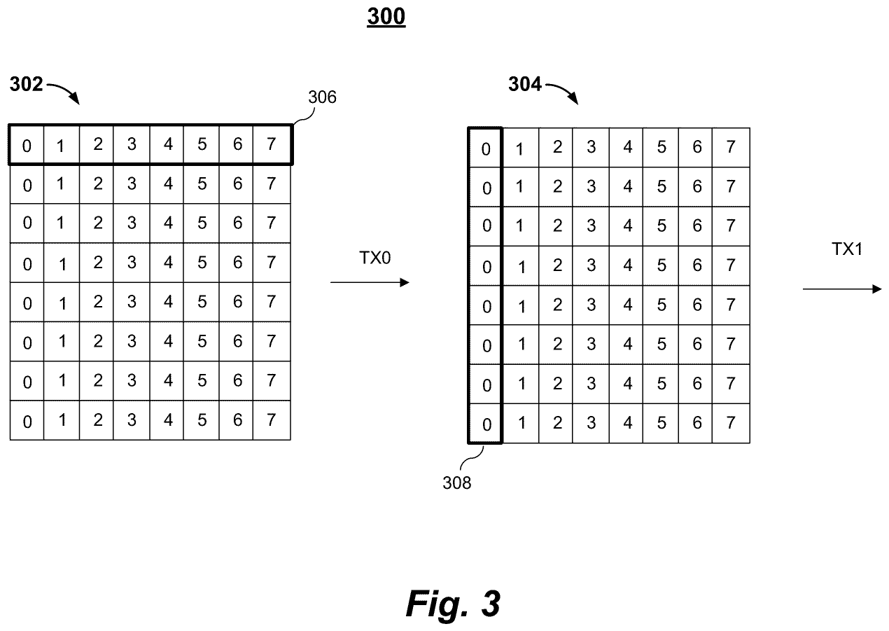

FIG. 3 illustrates an example 300 of a 2-dimensional transform of an 8×8 residue pixel block 302 performed by two stages of transform modules. The 8×8 residue pixel block 302 has eight rows and eight columns of pixels. Pixels in each row are numbered 0 to 7, from left to right. The pixels in block 302 are inputs to a first stage transform TX0. In particular, the pixels in block 302 may be read and processed by TX0 module 204 from the top row to the bottom row, and in each row, from the leftmost column to the rightmost column. For example, the first row 306 of pixels of block 302 may be read and processed by TX0 module 204 from the left to the right, i.e., from pixel #0 to pixel #7. The output of the TX0 transform is an 8×8 pixel block 304. Block 304 has eight rows and eight columns of pixels. Pixels in each row are numbered 0 to 7, from left to right. However, unlike transform TX0, the TX1 transform reads and processes the pixels in block 304 from the leftmost column to the rightmost column, and in each column, from the top row to the bottom row. The input to the TX1 transform is the transpose of the output of the TX0 transform. For example, the first column 308 of pixels of block 304 may be read and processed by TX1 module 208 from the top to the bottom, i.e., all the pixels numbered 0.

One technique of performing the two stages of transform modules with a transpose operation in between the two stages is to store the output of the TX0 transform in a ping-pong buffer. For example, during each cycle, the TX0 module reads and processes one row of the 8×8 residue pixel block 302, from the top row to the bottom row, and in each row, from the leftmost column to the rightmost column. The results are then written in the same order to a flip-flop array. Since the TX1 module needs to read column by column from the left to the right, the TX1 module needs to wait eight cycles for the TX0 to finish writing the 8×8 pixels output to the flip-flop array before the TX1 module may begin to start processing the output. However, storing the data in a large flip-flop array is very costly.

Another technique is to use static random-access memory (SRAM), which is less costly than flop-flop arrays, for storing the output from the TX0 module. However, SRAM only allows reading from it one row per column at each cycle. For example, the TX1 module may read the top element of column 308 of pixels of block 304 in the first cycle, the second element in the second cycle, and so on. This takes the TX1 module a total of eight cycles to complete the reading of the entire column 308 of pixels of block 304, which is inefficient and therefore cannot meet the high throughput requirement of the video encoder. Therefore, an improved technique of performing the two stages of transform modules with a transpose operation in between the two stages would be desirable.

In the present application, a system and a method for storing and retrieving data for a multi-stage two-dimensional transform are disclosed. The system comprises a memory comprising storage elements arranged in a physical grid with physical rows and physical columns, wherein values stored in a same physical column of the physical grid are not simultaneously accessible during the same cycle. The system further comprises a processing unit configured to receive data elements of a certain logical row of a dataset arranged in logical rows and logical columns for storage in a certain physical row of the physical grid of the memory. The processing unit is configured to circularly shift the data elements based on a shift offset associated with the certain physical row of the physical grid of the memory. The processing unit is configured to provide for storage in the certain physical row of the physical grid of the memory the circularly shifted data elements to enable a logical column of the dataset to be read together from different physical columns of the physical grid of the memory.

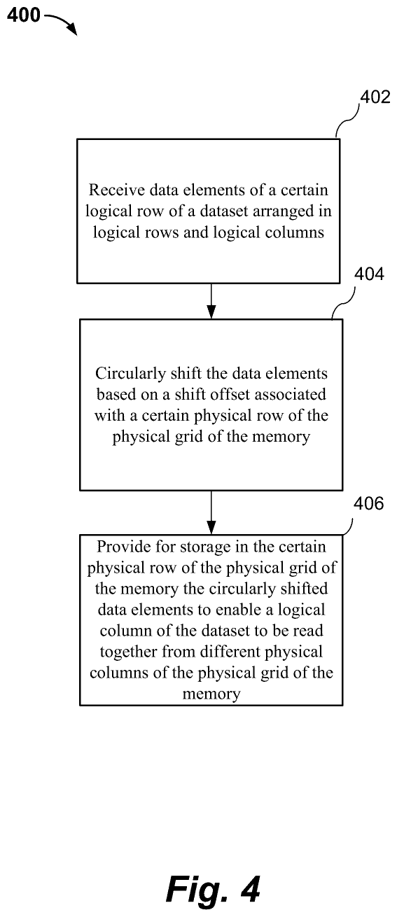

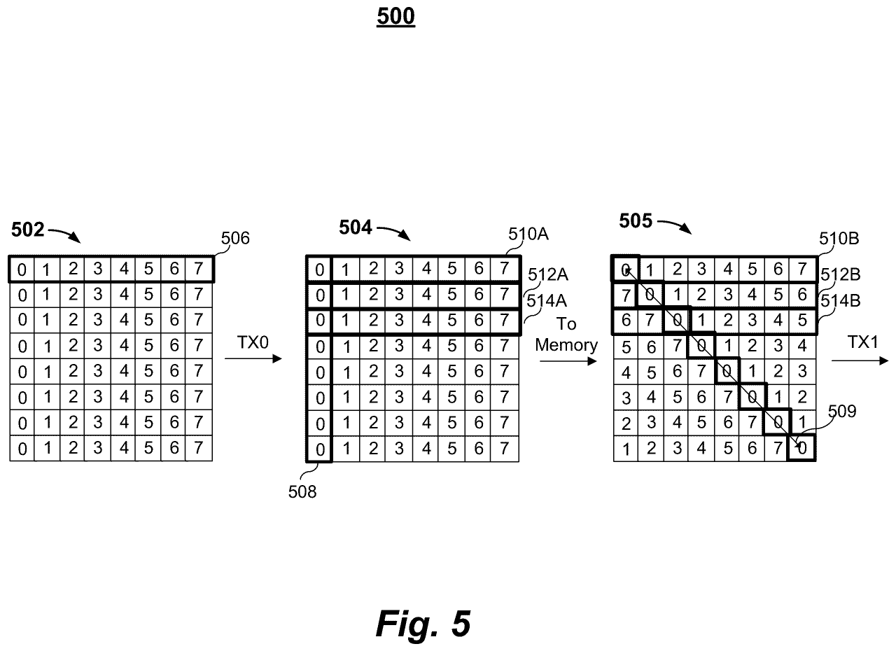

FIG. 4 illustrates an exemplary process 400 for storing and retrieving data. FIG. 5 illustrates an example 500 of a 2-dimensional transform of an 8×8 residue pixel block 502 performed by two stages of transform modules. In some embodiments, the two stages may use process 400 for storing and retrieving data that is passed from the first stage to the second stage of the 2-dimensional transform.

As shown in FIG. 5, the 8×8 residue pixel block 502 has eight rows and eight columns of pixels. Pixels in each row are numbered 0 to 7, from left to right. The pixels in block 502 are inputs to a first stage transform TX0. In particular, the pixels in block 502 may be read and processed by a TX0 module (e.g., TX0 module 204) from the top row to the bottom row, and in each row, from the leftmost column to the rightmost column. For example, the first row 506 of pixels of block 502 may be read and processed by TX0 module 204 from the left to the right, i.e., from pixel #0 to pixel #7. The output of the TX0 transform is an 8×8 pixel block 504. Block 504 also has eight rows and eight columns of pixels. Pixels in each row are numbered 0 to 7, from left to right.

As shown in FIG. 4, at step 402, for storage in a certain physical row of the physical grid of the memory, data elements of a certain logical row of a dataset arranged in logical rows and logical columns are received. For example, as the TX0 module reads and processes row by row from the top row to the bottom row of block 502, the output of the TX0 module (i.e., block 504) is generated row by row from the top row to the bottom row. The 8×8 pixel block 504 is a dataset with 64 data elements arranged in eight logical rows and eight logical columns, and the data elements in each row are received from left to right during a cycle. Each logical row of the data elements may be received by a processing unit such that the data elements may be stored in a physical row of a memory. The memory comprises storage elements that are arranged in a physical grid with a plurality of physical rows and a plurality of physical columns. For example, as shown in FIG. 5, a memory 505 comprises 64 storage elements that are arranged in a physical grid with eight physical rows and eight physical columns. A logical row of block 504 is stored in a physical row of memory 505. For example, the logical row 510A of block 504 is stored in the physical row 510B of memory 505. The logical row 512A of block 504 is stored in the physical row 512B of memory 505. The logical row 514A of block 504 is stored in the physical row 514B of memory 505, and so on.

In some embodiments, the values stored in the same physical column of the physical grid are not simultaneously accessible during a same cycle. In some embodiments, only one row of the physical column of the physical grid is accessible during a same cycle. For example, memory 505 may be a static random-access memory (SRAM). SRAM only allows reading from it one row per column during each cycle.

At step 404, the data elements are circularly shifted based on a shift offset associated with the certain physical row of the physical grid of the memory. When the data elements of a logical row are circularly shifted by one each time, each data element (except the current rightmost data element in the logical row) is shifted to the right by one, and the current rightmost data element is moved to the leftmost position in the row. For example, as shown in FIG. 5, the data elements of logical row 510A are circularly shifted by a shift offset of zero, which is [0, 1, 2, 3, 4, 5, 6, 7]. The shift offset of zero is associated with the top physical row 510B of memory 505. The data elements of logical row 512A are circularly shifted by a shift offset of one, which is [7, 0, 1, 2, 3, 4, 5, 6]. The shift offset of one is associated with the second physical row 512B of memory 505. The data elements of logical row 514A are circularly shifted by a shift offset of two, which is [6, 7, 0, 1, 2, 3, 4, 5]. The shift offset of two is associated with the third physical row 514B of memory 505. The remaining logical rows are circularly shifted using shift offsets of 3 to 7. As shown in this example, the shift offset associated with a certain physical row of the physical grid of the memory is different from other shift offsets associated with other physical rows of the physical grid of the memory. The shift offset for the physical rows (top to bottom) are 0, 1, 2, 3, 4, 5, 6, and 7. The shift offset associated with a certain physical row of the physical grid of the memory and the other shift offsets associated with other physical rows of the physical grid of the memory are selected from a number between zero and the total number of physical rows of the physical grid of the memory minus one (i.e., 8−1=7 in this example).

At step 406, the circularly shifted data elements are provided for storage in the certain physical row of the physical grid of the memory to enable a logical column of the dataset to be read together from different physical columns of the physical grid of the memory. The circularly shifted data elements of a logical row are then saved in memory 505. After the circularly shifted data elements corresponding to the eight logical rows 510A, 512A, 514A, etc. are saved into memory 505, a logical column of the dataset may be read together from different physical columns of the physical grid of the memory. For example, as shown in FIG. 5, the data elements of the first logical column 508 of pixels of block 504 (all the pixels numbered 0) are stored in a portion 509 of memory 505 and that portion may be read and processed by the TX1 module together. As shown in FIG. 5, each storage element of the portion 509 of memory 505 is located on a different physical column of the physical grid of the memory. Because each data element of logical column 508 is stored in a different physical column of the physical grid of the memory from other data elements of the logical column of the dataset, the logical column 508 of the dataset is readable during a same cycle. This technique is time and cost efficient. In addition, it is also area and power efficient.

This improved technique has many applications. For example, this improved technique may be used to store and retrieve data that is passed between any two stages of processing where the second stage is required to read the transpose of the output of the first stage of processing, wherein the output of the first stage of processing is a 2-dimensional dataset or matrix.

In example 500, the dataset arranged in the logical rows and the logical columns is an output of the first stage of a 2-dimensional transform, e.g., TX0 module 204. And the input of the second stage of the 2-dimensional transform, e.g., TX1 module 208, is a transpose of the output of the first stage of the 2-dimensional transform. The 2-dimensional transform is a transform for residues of a rate-distortion optimization (RDO) module in a video encoder.

The improved technique may also be used to store and retrieve data that is passed between the two stages of a 2-dimensional transform that is an inverse transform for outputs of an inverse quantization module in a rate-distortion optimization (RDO) module in a video encoder. For example, the dataset arranged in the logical rows and the logical columns is an output of the first stage of a 2-dimensional transform, e.g., IT0 module 214. And the input of the second stage of the 2-dimensional transform, e.g., IT1 module 218, is a transpose of the output of the first stage of the 2-dimensional transform.

Although the foregoing embodiments have been described in some detail for purposes of clarity of understanding, the disclosure is not limited to the details provided. There are many alternative ways of implementing the disclosure. The disclosed embodiments are illustrative and not restrictive.

What is claimed is:

1. A system, comprising:
a memory comprising storage elements arranged in a physical grid with physical rows and physical columns; and
a processing unit configured to:
for storage in a certain physical row of the physical grid of the memory, receive data elements of a certain logical row of a dataset arranged in logical rows and logical columns, wherein the certain logical row and the certain physical row correspond to one another, and wherein the certain logical row and the certain physical row each have a same width;
circularly shift the data elements of the certain logical row of the dataset based on a shift offset associated with the certain physical row of the physical grid of the memory; and
provide for storage in the certain physical row of the physical grid of the memory the circularly shifted data elements of the certain logical row of the dataset to enable a logical column of the dataset to be read together from different physical columns of the physical grid of the memory.

2. The system of claim 1, wherein values stored in a same physical column of the physical grid are not simultaneously accessible during a same cycle.

3. The system of claim 1, wherein only one row of a physical column of the physical grid is accessible during a same cycle.

4. The system of claim 1, wherein the memory comprises a static random-access memory (SRAM).

5. The system of claim 1, wherein the dataset arranged in the logical rows and the logical columns comprises an output of a first stage of a 2-dimensional transform, and wherein an input of a second stage of the 2-dimensional transform comprises a transpose of the output of the first stage of the 2-dimensional transform.

6. The system of claim 5, wherein the 2-dimensional transform comprises a transform for residues of a rate-distortion optimization (RDO) module in a video encoder.

7. The system of claim 5, wherein the 2-dimensional transform comprises an inverse transform for outputs of an inverse quantization module in a rate-distortion optimization (RDO) module in a video encoder.

8. The system of claim 1, wherein the shift offset associated with the certain physical row of the physical grid of the memory is different from other shift offsets associated with other physical rows of the physical grid of the memory.

9. The system of claim 8, wherein the shift offset associated with the certain physical row of the physical grid of the memory and the other shift offsets associated with the other physical rows of the physical grid of the memory are selected from a number between zero and a total number of physical rows of the physical grid of the memory minus one.

10. The system of claim 1, wherein a data element of a logical column of the dataset is stored in a different physical column of the physical grid of the memory from other data elements of the logical column of the dataset such that the logical column of the dataset is readable during a same cycle.

11. A method, comprising:
for storage in a certain physical row of a physical grid of a memory, receiving data elements of a certain logical row of a dataset arranged in logical rows and logical columns, wherein the memory comprises storage elements arranged in the physical grid with physical rows and physical columns, wherein the certain logical row and the certain physical row correspond to one another, and wherein the certain logical row and the certain physical row each have a same width;
circularly shifting the data elements of the certain logical row of the dataset based on a shift offset associated with the certain physical row of the physical grid of the memory; and
providing for storage in the certain physical row of the physical grid of the memory the circularly shifted data elements of the certain logical row of the dataset to enable a logical column of the dataset to be read together from different physical columns of the physical grid of the memory.

12. The method of claim 11, wherein values stored in a same physical column of the physical grid are not simultaneously accessible during a same cycle.

13. The method of claim 11, wherein only one row of a physical column of the physical grid is accessible during a same cycle.

14. The method of claim 11, wherein the dataset arranged in the logical rows and the logical columns comprises an output of a first stage of a 2-dimensional transform, and wherein an input of a second stage of the 2-dimensional transform comprises a transpose of the output of the first stage of the 2-dimensional transform.

15. The method of claim 11, wherein the shift offset associated with the certain physical row of the physical grid of the memory is different from other shift offsets associated with other physical rows of the physical grid of the memory.

16. The method of claim 15, wherein the shift offset associated with the certain physical row of the physical grid of the memory and the other shift offsets associated with the other physical rows of the physical grid of the memory are selected from a number between zero and a total number of physical rows of the physical grid of the memory minus one.

17. The method of claim 11, wherein a data element of a logical column of the dataset is stored in a different physical column of the physical grid of the memory from other data elements of the logical column of the dataset such that the logical column of the dataset is readable during a same cycle.

18. A system, comprising:
a processor configured to:
for storage in a certain physical row of a physical grid of a data memory, receive data elements of a certain logical row of a dataset arranged in logical rows and logical columns, wherein the data memory comprises storage elements arranged in the physical grid with physical rows and physical columns, wherein the certain logical row and the certain physical row correspond to one another, and wherein the certain logical row and the certain physical row each have a same width;
circularly shift the data elements of the certain logical row of the dataset based on a shift offset associated with the certain physical row of the physical grid of the data memory; and
provide for storage in the certain physical row of the physical grid of the data memory the circularly shifted data elements of the certain logical row of the dataset to enable a logical column of the dataset to be read together from different physical columns of the physical grid of the data memory; and
a memory coupled to the processor and configured to provide the processor with instructions.

19. The system of claim 18, wherein values stored in a same physical column of the physical grid are not simultaneously accessible during a same cycle.

20. The system of claim 18, wherein the dataset arranged in the logical rows and the logical columns comprises an output of a first stage of a 2-dimensional transform, and wherein an input of a second stage of the 2-dimensional transform comprises a transpose of the output of the first stage of the 2-dimensional transform.
